(19) United States
(12) Patent Application Publication
(10) Pub. No.: US 2023/0312907 A1
(43) Pub. Date: Oct. 5, 2023

(54) RESIN-CONTAINING COMPOSITION WITH ANTIMICROBIAL PROPERTIES, IN PARTICULAR BIOCIDAL PROPERTIES, FOR SURFACE COATINGS ON PAPER LAYERS OR WOOD-BASED PANELS

(71) Applicant: SWISS KRONO Tec AG, Luzern (CH)

(72) Inventors: Andreas Gier, Mandelbachtal (DE); Joachim Hasch, Berlin (DE); Norbert Kalwa, Horn-Bad Meinberg (DE)

(21) Appl. No.: 18/024,364

(22) PCT Filed: Aug. 25, 2021
(86) PCT No.: PCT/EP2021/073513

§ 371 Date: Mar. 2, 2023

(30) Foreign Application Priority Data
Sep. 3, 2020 (EP) 20194328.9
Dec. 4, 2020 (EP) 20211912.9

(51) Int. Cl. C08L 61/28; C08K 5/5435; C08K 5/09; C08K 5/00; C08K 3/36; C08K 5/19; C08K 5/544; C08K 5/136; C09D 5/14; C09D 161/28; D21H 19/24; D21H 21/36

(52) U.S. Cl. CPC C08L 61/28; C08K 5/5435; C08K 5/09; C08K 5/0091; C08K 3/36; C08K 5/19; C08K 5/544; C08K 5/136; C09D 5/14; C09D 161/28; D21H 19/24; D21H 21/36

(57) ABSTRACT

Provided is a composition having antimicrobial, biocidal properties, in particular antiviral properties, for surface coatings of paper layers or material panels. The composition includes at least one formaldehyde resin, in particular a melamine-formaldehyde resin, at least one compound of general formula (I) R¹SiX₃ (I), where X is alkoxy, and R¹ is an organic moiety selected from the group comprising C1-C10 alkyl, which may be interrupted by —O— or —NH—, and where R¹ has at least one functional moiety Q₁ selected from a group including an amino, methacrylic, methacryloxy, vinyl and epoxy group, at least one further compound of the general formula (II) SiX₄ (II), where X is alkoxy, and at least one antimicrobial agent, in particular at least one biocide.

### CROSS REFERENCE TO RELATED APPLICATIONS

This application is the United States national phase of International Patent Application No. PCT/EP2021/073513, filed Aug. 25, 2021, and claims priority to European Patent Application No. 20194328.9 filed Sep. 3, 2020 and European Patent Application No. 20211912.9, filed Dec. 4, 2020, the disclosures of which are hereby incorporated by reference in their entireties.

### BACKGROUND OF THE INVENTION

### Field of the Invention

The disclosure relates to a resin-containing composition with antimicrobial properties, in particular biocidal properties, for surface coatings on paper layers or material panels, the use of this composition, paper layers or wood-based panels coated therewith, as well as a method for producing a paper layer or wood-based panel provided with an antiviral coating.

### Description of Related Art

Wood-based panels and elements with a melamine surface are used in various areas for furniture, flooring and interior design. They are not only decorative, but also have excellent surface properties. In addition, it is increasingly required that they also have certain hygienic properties. Melamine surfaces are known to be easy and quick to disinfect. Also, the use of disinfectants typically does not lead to surface changes. However, there is often the problem that the surface finish only provides protection for a certain period of time because the active ingredient is not embedded in the surface. It is applied subsequently and is then removed from the surface again by cleaning or wear.

In the best case, the surfaces should not require disinfection at all, as they are per se antibacterial or antiviral. This applies in particular to healthcare applications such as doctors' surgeries, hospitals, retirement homes, rehabilitation facilities, etc. Effective and long-lasting protection against bacteria or viruses should therefore be embedded in the decorative surface so that, in the best case, permanent protection is guaranteed. Especially as a slowly deteriorating protection creates uncertainty about the remaining effectiveness.

An example of such an approach is described in WO 2013/156595 A1. Here, a surface-active substance or surfactant is provided with a nanomaterial, whereby an antimicrobial nanomaterial complex is formed. The surfactant used is a quaternary ammonium cation-containing surfactant. Silicon nanoparticles or carbon nanotubes are designated as the nanomaterial. The antimicrobial complex formed is used to coat surfaces.

Providing wood-based panels with permanent antimicrobial protection of the surfaces is difficult to accomplish by laypersons, as they are usually not informed about the exact boundary conditions of production and application (application quantities, application conditions, etc.). In addition, the preparations that have to be used are not harmless to health and should therefore only be applied by trained personnel. In addition, the repeated application at regular intervals leads to loss of use. These repeated applications naturally also lead to higher costs.

This results in various disadvantages, such as high effort, cumbersome solutions, permanent costs and uncertainty regarding the protective function.

### SUMMARY OF THE INVENTION

The proposed solution was therefore based on the technical problem of providing a melamine resin surface with an antiviral component. This should be embedded in the resin matrix in the area of the surface. Of course, the addition of the active ingredient should not worsen the surface properties of the product. It should also be possible to produce the antiviral surface on the existing equipment. Under no circumstances should a toxic hazard emanate from the modified surface that would limit the possible applications in any way.

This object is solved according to the proposed solution by a composition having features as described herein.

Accordingly, a resin-containing composition having antimicrobial, biocidal properties, in particular antiviral properties, is provided for surface coatings of paper layers or material panels, the composition comprising:
at least one formaldehyde resin, in particular a melamine-formaldehyde resin,
at least one compound of the general formula (I)

R¹SiX₃ (I),
where
   X is alkoxy, and
   R¹ is an organic moiety selected from the group comprising C1-C10 alkyl, which may be interrupted by —O— or —NH—, and
   wherein R¹ has at least one functional moiety Q₁ selected from a group containing an amino, methacrylic, methacryloxy, vinyl and epoxy group, and
at least one further compound of the general formula (II)

SiX₄ (II),
where X is alkoxy, and
at least one antimicrobial agent, in particular at least one biocide,

The present composition enables the incorporation or embedding of biocidal active ingredients in a resin mixture or resin matrix, such as a melamine resin matrix, which are applied to surfaces of substrate materials such as wood-based panels or paper layers. For this purpose, the present composition comprises a crosslinking hydrophilic component with the at least one silane compound of the general formula (I) and optionally, a further silane compound of the general formula (II). The silane compound of formula (I) binds to the resin component and the antimicrobial agent via the functional groups Q1. The silane compound of formula (II) serves to build up a SiO₂ network via condensation of the OH groups, binding to melamine resin and the antimicrobial agent. The biocidal active ingredient is coupled to the silanes. The complex of active ingredient and silane can then be firmly integrated into the melamine resin via the condensation processes that take place during curing or pressing.

It should be noted that the present resin-containing composition is not applied to inorganic, leather-containing, glass-containing, metal- or semi-metal-containing coatings, surfaces or materials. In particular, the present resin-containing composition is applied exclusively to cellulosic surfaces and materials, such as paper and wood-based materials, but not textiles.

Nanoscale particles, which can be added optionally as described below, enable further uptake of active ingredient and incorporation via OH groups into the resin matrix due to the large surface area of e.g. more than 200 m²/g.

In addition to silanes, other alkoxides, in particular alkoxy titanates such as titanium isobutylate, can also be used as a bonding agent between the resin and the active ingredient, but in contrast to silanes, this hydrolyses and condenses much more quickly.

The present composition can be used as a coating or impregnating resin. In the case of impregnating resins, the present resin-containing composition can be applied to the upper surface of the core-impregnated paper layer (impregnate) after core impregnation of paper layers (decorative paper, overlay paper) with the commonly used impregnating resins and intermediate drying. However, the present resin-containing composition can also be applied to a printed wood-based panel.

The use of the present composition offers various advantages. For example, the embedding of the active ingredient in the resin matrix results in permanent antimicrobial protection; washing out the active ingredient is difficult or impossible. In addition, disinfection costs are reduced because the active ingredient is only introduced into the surface layer once; repeated application of a disinfectant can be avoided.

In a further embodiment, it is also possible that silane and the biocide are not used as individual components that form a silane-biocide complex after reaction, but that an already finished silane-biocide complex such as 3-trimethoxysilylpropyldimethyloctylammonium chloride is used.

The hydrolysable moiety X of the general formulae (I) and (II) is advantageously selected from a group containing C₁₋₆-alkoxy, in particular methoxy, ethoxy, n-propoxy, i-propoxy and butoxy.

In a particularly preferred variant of the present composition, the compound of the general formula (II) of the formula SiX₄ comprises methoxy, ethoxy, n-propoxy or i-propoxy and butoxy, as X.

Particularly preferred are the compounds tetramethoxysilane and tetraethoxysilane as compound of the general formula (II).

The organic moiety R¹ of the compound of the general formula (I) is preferably selected from a group comprising methyl, ethyl, n-propyl, isopropyl, n-butyl, s-butyl, t-butyl, pentyl, hexyl, heptyl, octyl, cyclohexyl, which may be interrupted by —O— or —NH—.

In one embodiment of the present composition, the at least one functional moiety Q1 of the compound of the general formula (I) is selected from a group comprising epoxy, amino and vinyl. Particularly preferred functional groups Q1 are glycidyloxy-, aminoethylamino. The functional moiety Q1 can advantageously have a moiety with a double bond or an epoxide group which can be activated and polymerised by means of UV radiation.

In a variant of the present composition, compounds of the general formula (I) according to R¹ SiX₃, with a functional moiety Q1 may be selected from methacryloxypropyltrimethoxysilane (MPTS), aminoethyl-aminopropyltrimethoxysilane, silanes with an epoxy functionalisation such as glycidyl-oxypropyltriethoxysilane, or silanes with a vinyl functionalisation such as vinyltrimethoxysilane.

As described, the moiety R¹ can have at least one functional moiety Q1. In addition, the moiety R¹ can also be substituted with further moieties.

The term “substituted”, in use with “alkyl”, “cycloalkyl”, “aryl”, etc., denotes the substitution of one or more atoms, usually H atoms, by one or more of the following substituents, preferably by one or two of the following substituents: halogen, hydroxy, protected hydroxy, oxo, C₃-C₇-cycloalkyl, bicyclic alkyl, phenyl, naphthyl, amino, protected amino, monosubstituted amino, protected monosubstituted amino, disubstituted amino, guanidino, protected guanidino, a heterocyclic ring, a substituted heterocyclic ring, imidazolyl, indolyl, pyrrolidinyl, C₁-C₁₂-alkoxy, C₁-C₁₂-acyl, C₁-C₁₂-acyloxy, acryloyloxy, nitro, carboxy, protected carboxy, carbamoyl, cyano, methylsulfonylamino, thiol, C₁-C₁₀-alkylthio and C₁-C₁₀-alkylsulfonyl. The substituted alkyl groups, aryl groups, alkenyl groups, may be substituted once or several times and preferably once or twice, with the same or different substituents.

The term “aryl” as used herein means aromatic hydrocarbons, for example, phenyl, benzyl, naphthyl, or anthryl. Substituted aryl groups are aryl groups substituted with one or more substituents as defined above.

The term “cycloalkyl” includes the groups cyclopropyl, cyclobutyl, cyclopentyl, cyclohexyl and cycloheptyl.

In one variant, at least one compound of the general formula (I) and at least one compound of the general formula (II), or at least two compounds of the general formula (I) and at least one compound of the general formula (II) may be present. Any combination is conceivable here.

Thus, one embodiment of the resin-containing composition may comprise:
at least one formaldehyde resin, in particular a melamine-formaldehyde resin,
at least one compound of the general formula (I) R¹SiX₃, wherein X is alkoxy, and R¹ is an organic moiety selected from the group comprising C1-C10 alkyl, which may be interrupted by —O— or —NH—, and wherein R¹ has at least one functional moiety Q₁ which is selected from a group containing a vinyl and epoxy group, and
at least one further compound of the general formula (II) SiX₄, wherein X is alkoxy.

These silanes have proven to be particularly advantageous for the incorporation and chemical bonding of biocides with functional groups such as hydroxy groups or carboxy groups into the resin matrix.

Another embodiment of the resin-containing composition may comprise:
at least one formaldehyde resin, in particular a melamine-formaldehyde resin,
at least one first compound of the general formula (I) R¹SiX₃, wherein X is alkoxy, and R¹ is an organic moiety selected from the group comprising C1-C10 alkyl, which may be interrupted by —O— or —NH—, and wherein R¹ has at least one functional moiety Q₁ which is selected from a group containing a vinyl and epoxy group,
at least one second compound of the general formula (I) R¹SiX₃, wherein X is alkoxy, and R¹ is an organic moiety selected from the group comprising C1-C10 alkyl which may be interrupted by —O— or —NH—, and wherein R¹ has at least one functional moiety Q₁ selected from a group containing an amino group, and
at least one further compound of the general formula (II) SiX₄, wherein X is alkoxy.

This silane mixture has proven to be particularly advantageous for the incorporation and chemical binding of biocides that are amenable to complexation, such as copper sulphate.

In a particularly preferred variant, the composition may comprise glycidyloxypropyltriethoxysilane as compound of formula (I) and tetraethoxysilane as compound of formula (II). In another preferred variant, the composition may comprise glycidyloxypropyltriethoxysilane as the first compound of formula (I), aminoethylaminepropyltriethoxysilane as the second compound of formula (I) and tetraethoxysilane as the compound of formula (II).

The molar ratios of the compound of formula (I) and formula (II) in the composition may range from 0.5:1 to 25:1, preferably from 5:1 to 15:1. Thus, the molar ratio of glycidyloxypropyltriethoxysilane to tetraethoxysilane may be between 0.8:1 to 4:1, and the molar ratio of glycidyloxypropyltriethoxysilane to aminoethylaminepropyltriethoxysilane may be between 0.7:1 to 2:1.

As indicated above, the antimicrobial agent used is a biocide. Preferably, biocides containing silver or zinc are not used. A prerequisite for the selection of a suitable biocide is that it complies with EU Regulation No. 528/2012 concerning the placing of biocidal products on the market. Biocides can be classified either according to product types such as disinfectants and protectants or according to their target organisms (virucides, bactericides, fungicides, etc.). Another essential requirement is the compatibility of the biocide with the resin used.

Presently, the at least one biocide may be selected from a group comprising benzalkonium chloride, octylammonium chloride, chitosan, phenylphenol, copper sulphate, lactic acid, nonanoic acid, sodium benzoate, 1-[[2-(2,4-dichlorophenyl)-4-propyl-1,3-dioxolan-2-yl]methyl]-1H-1,2,4-triazoles, 2-octyl-2H-isothiazol-3-ones, thiazol-4-yl-1H-benzoimidazoles, 3-iodo-2-propynylbutylcarbamate, biphenyl-2-ol, bronopol/calcium magnesium oxide, copper (II) oxide, 2-pyridinethiol-1-oxide, 4-chloro-meta-cresol. Particularly preferred biocides are benzalkonium chloride, chitosan, phenylphenol, copper sulphate, 4-chloro-3-methylphenol. The active substances listed are from product families 2 and 9, which are already approved or in the process of being approved for antiviral floors.

The at least one biocide may be present in the present composition in an amount (based on the amount of the composition of two silanes and biocide, excluding resin) of between 10 and 30% by weight, preferably between 15 and 25% by weight, more preferably between 18 and 23% by weight, e.g. 20% by weight or 22% by weight.

In a particularly preferred embodiment, it is provided that the resin-containing composition contains more than one biocide, in particular at least two biocides.

It has been found that in the case of certain biocides, such as phenylphenol, high amounts of the biocide, e.g. above 20% by weight, can lead to a segregation of the resin-containing composition and thus to optical inhomogeneities on the surfaces.

In order to nevertheless ensure a high efficacy of the antiviral additive in such cases, it has proven advantageous to add another biocide, such as 4-chloro-3-methylphenol, to the resin-containing composition, especially in an undershoot. In this way, segregation is avoided while ensuring good antiviral activity.

In the case of the use of two biocides, the first biocide may be used in an amount between 15 and 25% by weight, preferably 20% by weight, and the second biocide may be used in an amount between 0.1 and 2% by weight, preferably between 0.3 and 0.8% by weight, particularly preferably 0.5% by weight (in each case based on the amount of the composition of two silanes and biocide, without resin).

In a particularly preferred variant, phenylphenol is used as the first biocide and 4-chloro-3-methylphenol as the second biocide. The amount of phenylphenol can be 20% by weight and the amount of 4-chor-3-methylphenol can be 0.48% by weight.

However, it would also be possible to use the two biocides in a weight ratio of between 1:0.5 and 1:1.5, in particular of 1:1; i.e. the two biocides can be used in equal amounts, for example. The quantity ratio is controlled by the specific properties of the biocides used.

The molar ratio of silane to antiviral agent can range from 100:1 to 5:1.

In a further embodiment, the present composition may contain inorganic particles, in particular nanoparticles based on SiO₂, such as silica gels or zeolites. The particles preferably used in this case have a size between 2 and 400 nm, preferably between 2 and 100 nm, more preferably between 2 and 50 nm. By adding the inorganic particles, the amount of absorbed active ingredient can be further increased.

The mass ratio between oxide from alkoxides and oxide from additional nanoparticles ranges from 1.4: over 1.26:1 to 1:2.3. Typical silica gels are silica sols such as Levasil 200 B 30, CS 30 716P, CS 20 516P. These silica sols have a depot effect and can thus improve the effectiveness.

As already indicated above, in a still further embodiment, it may be provided to add at least one alkoxytitanate, such as tetraisopropyl orthotitanate (titanium isopropylate) or tetraisobutyl orthotitanate (titanium isobutylate), to the present composition. These serve as further binding agents between the resin and the active ingredient, but in the case of the alkoxytitanates, unlike the silanes, they hydrolyse and condense much more quickly. At the same time, it increases the condensation rate of the entire system, so that removal of the alcohol is easier and purely aqueous systems are thus accessible.

The silane to alkoxy titanate ratio is 30:1, preferably 26.6:1.

The present resin-containing composition is preferably used in aqueous form, which may contain no alcohol or a small amount of alcohol.

In the case of an aqueous composition, it may be prepared in a method comprising the following steps:
providing an aqueous suspension containing at least one compound of the general formula (I), and at least one compound of the general formula (II);
adding of at least one catalyst, in particular an acid, to the suspension of at least one compound of the formula (I) and at least one compound of the formula (II);
heating of the mixture;
adding of at least one antimicrobial agent and heating of the mixture if necessary;
optionally separating the alcoholic phase formed (e.g. by evaporation) from the aqueous phase of the mixture of at least one compound of the formula (I), at least one compound of the formula (II), and the at least one antimicrobial active substance;
adding of the mixture (or additive) of two silanes and biocide to a formaldehyde resin.

Inorganic and/or organic acids suitable as catalysts are selected from a group containing phosphoric acid, acetic acid, p-toluenesulfonic acid, hydrochloric acid, formic acid or sulfuric acid. Also suitable are ammonium salts such as ammonium sulphate, which react as weak acids. p-Toluenesulphonic acid is particularly preferred.

In the case that inorganic nanoparticles, such as silica sol, are added to the composition, they are preferably added together with the active ingredient. In one variant, however, the active ingredient can also be added after the silica sol, e.g. after the silica sol.

The prepared aqueous suspension of the composition of two silanes and biocide is stable and can be stirred as an additive into aqueous thermosetting formaldehyde resins such as melamine resins and used to create an antimicrobial surface. UV-curable polymers or lacquers are not used as a matrix for the antiviral composition or additive comprising the two silanes and the biocide.

However, it is also possible that the individual components; i.e. silanes and biocide, of the composition are mixed directly into the resin; i.e. in this case the composition is not present as a separate additive, but is rather produced in situ in the resin.

In this case, the composition is prepared in situ as follows:
providing a resin suspension, in particular a formaldehyde resin suspension such as a melamine formaldehyde resin;
adding of an aqueous suspension containing at least one compound of the general formula (I), and optionally at least one compound of the general formula (II);
adding of at least one catalyst, in particular an acid, to the suspension of at least one compound of the formula (I) and optionally at least one compound of the formula (II);
heating of the mixture;
adding of at least one antimicrobial agent and possibly inorganic nanoparticles, such as silica sol;
further heating of the mixture until the modified resin is obtained.

Accordingly, after addition of the antimicrobial composition as an additive to a resin or due to in situ preparation in a pre-prepared resin, a resin suspension based on a formaldehyde resin is provided which exhibits antimicrobial properties.

The amount of active ingredient or biocide added to the resin is adjusted so that the resin suspension has between 1 to 5 wt %, preferably between 2 to 3 wt % biocide based on the solid resin.

This antimicrobial resin suspension can be used to coat substrate materials, in particular paper layers, such as decorative or overlay paper layers, or in particular wood-based panels, such as chip panel, medium-density fibre (MDF), high-density fibre (HDF) or oriented strand board (OSB) panels, plywood panels or a plastic composite panel (WPC).

Accordingly, a method is also provided for producing a paper layer or wood-based panel provided with an antiviral effect, wherein the at least one paper layer or wood-based panel is provided with at least one coating, in particular as a surface coating, wherein the at least one coating comprises at least one resin-containing composition described above. The application of the resin suspension to a wood-based panel is typically carried out by means of rollers, and the application of the resin suspension to a paper layer is carried out by means of a grid unit.

Accordingly, a method is provided with which a surface coating of various carrier materials such as wood-based panels or paper layers is made possible, which has antimicrobial, biocidal properties, in particular antiviral properties. The carrier material provided by this method thus has at least one antivirally active coating, in particular at least one antivirally active surface coating.

In one embodiment, a decorative paper or overlay paper layer is used as the paper layer.

In this case, the present method enables the production of an antivirally active impregnate. In one variant, a decorative paper layer or an overlay paper layer is first impregnated with at least one liquid or powdery resin composition. Subsequently, at least one coating comprising at least one formaldehyde resin, in particular a melamine-formaldehyde resin, and at least one composition preparable from at least one compound of the general formula (I), at least one compound of the general formula (II) and at least one antimicrobial agent, in particular at least one biocide, is applied to at least one surface of the impregnated paper layer.

The impregnate produced by the present method thus has the following layer structure:
at least one paper layer impregnated with a resin, in particular a decorative paper layer or an overlay paper layer; and
at least one antivirally active coating provided on the at least one impregnated paper layer.

The term “impregnation” is understood to mean a complete or partial impregnation of the paper layer with the resin. Such impregnations can be applied, for example, in an impregnation bath, by rolling, by screen rolling, by doctoring or also by spraying.

As mentioned above, overlay, decorative or kraft papers are used as paper layers. Overlay papers are thin papers that have typically already been impregnated with a conventional melamine resin. There are also overlay papers available in which abrasion-resistant particles, such as corundum particles, are already mixed into the resin of the overlay to increase abrasion resistance. Decorative papers are special papers for surface finishing of wood-based materials, which allow a high variety of decors. In addition to the typical imprints of various wood structures, more extensive imprints of geometric shapes or artistic products are available. In fact, there is no restriction in the choice of motif. To ensure optimal printability, the paper used must have good smoothness and dimensional stability and also be suitable for penetration of a necessary synthetic resin impregnation. Kraft papers have a high strength and consist of cellulose fibres to which starch, alum and glue are added to achieve surface effects and strength increases.

The paper layers are impregnated in two stages. First, the core is impregnated with a standard resin (melamine or urea resin or mixtures of the two resins) with intermediate drying. Subsequently, a melamine resin is applied to the upper side of the impregnate with the corresponding active ingredient in the resin, e.g. in a grid unit. This is followed by another drying step. The impregnate pre-treated in this way is then further processed into the required intermediate or end product. This can be a direct coating for furniture, interior design or flooring applications. Laminates can also be produced, which can then also be used for the applications described above.

In one embodiment, the paper layers are treated as follows: First, the paper layer is impregnated on the reverse side (e.g. in an impregnation tank) with a resin with a solids content of between 50 and 70% by weight, preferably 55% by weight. After passing through a breathing section, the paper is impregnated with a resin by immersion. The impregnate then passes through a drying channel, where it has been dried back to a residual moisture content of 15-20%. In a second impregnation step, a resin with a solids content between 50 and 70 wt %, preferably 55 wt % containing the antimicrobial composition is applied. A further drying step is carried out to a residual moisture content of about 6%. The impregnate can then be pressed in the usual way with a wood-based panel, e.g. in a short-cycle press.

It is also possible to press the impregnate provided with the antivirally active coating with further paper layers. Thus, in a preferred embodiment, the one overlay paper layer provided with the antivirally active coating can be pressed with at least one decorative paper layer (not impregnated with the modified resin), at least one impregnated kraft paper layer and at least one transparent paper layer (pergamine). Such a layered structure may look from top to bottom as follows: an overlay paper layer provided with the antivirally active coating, a decorative paper layer (not impregnated with the modified resin), optionally a pergamine layer, a kraft paper layer impregnated with the modified resin, and a pergamine layer. The (flexible) laminate produced in this way can then be pressed to a wood-based panel or glued to the wood-based panel.

In another embodiment, the wood-based panel is preferably a wood particle panel, medium density fibre (MDF), high density fibre (HDF) or oriented strand board (OSB) panel, plywood panel or a plastic composite panel (WPC).

In this case, the present method enables the preparation of an antivirally active laminate.

In one variant, at least one decorative layer is first applied to the at least one wood-based panel, followed by at least one antiviral coating comprising at least one formaldehyde resin, in particular a melamine-formaldehyde resin, and at least one composition which can be prepared from at least one compound of the general formula (I), at least one compound of the general formula (II) and at least one antimicrobial agent, in particular at least one biocide. This layered structure is then pressed to form a laminate.

The laminate produced by the present method thus has the following layer structure:
at least one wood-based panel;
at least one decorative layer provided on the wood-based panel, in particular in the form of a direct print or a decorative paper layer, and
at least one antivirally active (resin-containing) coating provided on the at least one decorative layer.

In one embodiment, the decorative layer is applied to a wood-based panel as a substrate by direct printing or as a decorative paper layer. Subsequently, an antivirally active liquid resin layer comprising at least one formaldehyde resin, in particular a melamine-formaldehyde resin, and at least one composition preparable from at least one compound of the general formula (I) and at least one antimicrobial active substance, in particular at least one biocide, can be applied to the decorative layer. It is also possible to apply a paper layer provided with the antivirally active coating as a cover layer. This can be, for example, an overlay impregnate already described above.

Accordingly, the present method is for the manufacture of an antivirally active laminate for use as floor, wall or ceiling covering and furniture comprising a carrier for a decorative layer placed directly on the carrier or a decorative layer placed separately on the carrier and a cover layer placed directly on the decorative layer or a cover layer placed on the decorative layer, which are pressed together under the action of pressure and temperature to form the laminate, wherein the above-mentioned structures comprise an antivirally active melamine-formaldehyde resin at least in the outer coating or the outer layer.

The pressing temperature depends on the material of the substrate. In the case of wood fibre panels, such as MDF or HDF panels, or also chip panel, the pressing temperature is in a range between 170 and 230° C., preferably 190 and 200° C. In the case of wood plastic composite (WPC), however, the pressing temperatures must be reduced by 30-40° C. Thus, the pressing temperature for WPC panels is in a range between 130 and 180° C., e.g. 150° C.

As mentioned, in a preferred embodiment, the resin-containing antimicrobial composition may be applied to a printed wood-based panel.

For this purpose, a wood-based panel or carrier panel is first provided with a resin undercoat, on which at least one base coat layer is applied. The base coat layer preferably used comprises a composition of casein or soy protein as a binder and inorganic pigments, in particular inorganic colour pigments. White pigments such as titanium dioxide can be used as colour pigments in the base coat layer, or other colour pigments such as calcium carbonate, barium sulphate or barium carbonate. In addition to the colour pigments and the casein or soy protein, the base coat may also contain water as a solvent. It is also preferred if the applied pigmented base coat consists of at least one, preferably at least two, in particular preferably at least four successively applied layers or coatings, wherein the application quantity between the layers or coatings may be the same or different.

In another embodiment, a primer layer is applied to the base coat, preferably as a one-time application with subsequent drying. The primer layer is particularly useful in the case of a subsequent gravure printing process (with rollers), whereas it is not absolutely necessary when using a digital printing process.

The amount of liquid primer applied is between 10 and 30 g/m², preferably between 15 and 20 g/m². Polyurethane-based compounds are preferred as primers.

Gravure and digital printing processes are advantageously used as direct printing processes for printing the wood-based panel.

Covering layers with or without additives, which may vary in quantity and composition, are applied on top of the decorative layer.

Thus, the following orders can be carried out in one variant:
applying at least one first resin layer to the at least one decorative layer on the upper surface of the wood-based panel, wherein the first resin layer has a solids content of between 60 and 80% by weight, preferably 65% by weight;
drying of the first resin layer assembly in at least one drying device;
applying at least one second resin layer to the upper side and optionally to the lower side of the wood-based panel, wherein the second resin layer has a solids content of between 60 and 80 wt %, preferably 65 wt %;
optional uniform scattering of abrasion-resistant particles onto the second resin layer on the top of the wood-based panel;
subsequent drying of the second resin layer with the optional abrasion resistant particles in at least one drying device;
applying at least a third and a fourth resin layer, the third having a solids content of between 50 and 70% by weight, preferably 60% by weight,
subsequent drying of the applied third resin layer in at least one further drying device;
applying at least fourth resin layer, wherein the fourth resin layer has a solids content between 50 and 70 wt %, preferably 60 wt %;
subsequent drying of the applied fourth resin layer in at least one further drying device;
applying at least one resin suspension having a solids content of between 50 and 70% by weight, preferably 55% by weight, comprising the antimicrobial composition according to the solution,
subsequent drying of the applied resin suspension in at least one further drying apparatus; and
Pressing of the layer structure in a short-cycle press.

In one embodiment, glass beads can be applied with the third, fourth and/or fifth resin layer to act as spacers. The glass beads preferably used have a diameter of 80-100 μm. The amount of glass beads is 10 to 50 g/m², preferably 10 to 30 g/m², more preferably 15 to 25 g/m². The batch preferably consists of about 40 kg resin liquid plus glass beads and auxiliary materials. The glass beads can also be in silanised form. Silanisation of the glass beads improves the embedding of the glass beads in the resin matrix.

As also mentioned above, abrasion-resistant particles, such as particles of corundum (aluminium oxides), boron carbides, silicon dioxides, silicon carbides, can be sprinkled onto the wood-based panel. Particles of corundum are particularly preferred. Preferably, these are high-grade corundum (white) with a high transparency, so that the optical effect of the underlying decor is adversely affected as little as possible.

The amount of scattered abrasion-resistant particles is 10 to 50 g/m², preferably 10 to 30 g/m², more preferably 15 to 25 g/m². The amount of scattered abrasion-resistant particles depends on the abrasion class to be achieved and the particle size. Thus, in the case of abrasion class AC3, the amount of abrasion-resistant particles is in the range between 10 to 15 g/m², in abrasion class AC4 between 15 to 20 g/m² and in abrasion class AC5 between 20 to 35 g/m² when using grit size F200. In the present case, the finished panels preferably have abrasion class AC4.

Abrasion-resistant particles with grain sizes in classes F180 to F240, preferably F200, are used. The grain size of class F180 covers a range of 53-90 μm, F220 from 45-75 μm, F230 34-82 μm, F240 28-70 μm (FEPA standard). In one variant, white F230 white corundum is used as abrasion-resistant particles.

The drying of the resin layers takes place at dryer temperatures between 150 and 220° C., preferably between 180 and 210° C., especially in a convection dryer. The temperature is adapted to the respective resin layers and can vary in the individual convection dryers. However, other dryers can be used instead of convection dryers.

In the pressing step following the last drying step, the layer structure is pressed under the influence of pressure and temperature in a short-cycle press at temperatures between 150 and 250° C., preferably at 160° C., and a pressure between 30 and 60 kg/cm². The pressing time is between 10 and 20 sec, preferably between 12 and 14 sec.

### DESCRIPTION OF THE INVENTION

The proposed solution is explained in more detail below with reference to examples of embodiments.

### Example 1: A First Antimicrobial Additive AV-1

This is an aqueous additive that can be mixed into the resin during production.

Description of the preparation of the additive AV-1: Preparation of 214 μg glycidyloxypropyltriethoxysilane in a stirred flask. Addition of 9 g of 10% acetic acid. After stirring for 10 minutes at room temperature, 10 g titanium isobutylate is added and stirred for a further 10 minutes. Then 391 g silica sol CS 30 716P is added. The mixture heats up to approx. 60° C. by hydrolysis and is now heated to 80° C. and boiled at reflux. After about 50 minutes, benzalkonium chloride in water (20% solution) is added and 8 g aminoethylaminopropyltriethoxysilane is added. The hyrolysate is boiled for a further 60 minutes at 80° C. under reflux. The mixture is then diluted with a further 85 g of water and a rotary evaporator is used to remove the ethanol produced during the hydrolysis. After removal of the alcohol, the mixture has a flash point of over 85° C. This additive can now be added to the finished melamine resin.

### Example 2: A Second Antimicrobial Additive AV-2

This is an aqueous additive with residual alcohol which can be mixed into the resin during production.

Description of the preparation of the additive AV-2: Preparation of 59.7 g glycidyloxypropyltriethoxysilane and 10.91 g tetraethoxysilane in a stirred flask. Addition of a mixture consisting of 30.98 g H₂O, 5 g ethanol and 2.24 g para-toluenesulfonic acid. The mixture heats up to approx. 55° C. and is further stirred for approx. 60 minutes. Part of the alcohol formed during the hydrolysis is removed after 12 hours of standing time with the help of a rotary evaporator. The weight of the mixture is thereby reduced by 17 wt. %. To 10 g of this hydrolysate, another 10 g of H₂O and 0.352 g of para-toluenesulphonic acid are now added. With the aid of a dispersing stirrer, 0.51 g of chitosan is now dissolved in this mixture. After a 10-minute stirring time, a transparent, highly viscous additive is obtained, which can now be added to the finished resin.

### Example 3: A Third Antimicrobial Additive AV-3

This is an aqueous additive with residual alcohol which can be mixed into the resin during production.

Description of the preparation of the additive AV-3: Preparation of 20.0 g glycidyloxypropyltriethoxysilane and 12.8 g tetraethoxysilane in a stirred flask. Addition of a mixture consisting of 18.1 g H₂O, 2 g ethanol and 0.76 g para-toluenesulfonic acid. The mixture heats up to approx. 55° C. and is stirred for approx. 60 minutes. Under reflux the mixture is now heated to 80° C. and after 60 minutes 8.4 g phenylphenol are added to the mixture. The hydrolysate is now boiled at 80° C. for another 60 minutes. Part of the alcohol formed during the hydrolysis is removed after 12 hours by means of a rotary evaporator. The weight of the mixture is reduced by 12 wt. %. A transparent additive is obtained, which can now be added to the finished resin.

### Example 4: A Fourth Antimicrobial Additive AV-4

This is an additive that is produced in the resin (in situ) and therefore cannot be used as a stand-alone additive.

Description of the preparation of the additive AV-4: 215 g melamine resin (delivered from Heiligengrabe) are placed in a stirring flask. Addition of a mixture consisting of: 8.0 μg glycidyloxypropyltriethoxysilane, 7.1 g tetraethoxysilane as well as 5.2 g aminoethyl-aminopropyltriethoxysilane and a mixture consisting of 12.2 g H₂O, 0.44 g para-toluenesulfonic acid. The mixture is heated to approx. 45 g and stirred for 60 minutes. Then 2.91 g copper sulphate and 9.8 g silica sol CS 20 516 P are added and stirred for another 12 hours. A translucent, slightly bluish modified resin is obtained.

### Example 5: A Fifth Antimicrobial Additive AV-5

This is an additive that is produced in the resin (in situ) and therefore cannot be shipped as a stand-alone additive.

Description of the preparation of the additive AV-5: Preparation of 215 g melamine resin (delivery from Heiligengrabe) in a stirring flask. Addition of a mixture consisting of: 8.0 μg glycidyloxypropyltriethoxysilane, 7.1 g tetraethoxysilane as well as 5.2 g aminoethyl-aminopropyltriethoxysilane and a mixture consisting of 12.2 g H₂O, 0.44 g para-toluenesulfonic acid. The mixture is heated to approx. 45 g and stirred for 60 minutes. Then 1.99 g copper sulphate and 9.8 g silica sol 200 B 30 are added and stirred for another 12 hours. A translucent, slightly greyish modified resin is obtained.

### Example 6: A Sixth Antimicrobial Additive AV-6

This is an additive that is produced in the resin (in situ) and therefore cannot be shipped as a stand-alone additive.

Description of the preparation of the additive AV-6: 215 g melamine resin (delivered from Heiligengrabe) are placed in a stirring flask. Addition of a mixture consisting of: 8.0 g glycidyloxypropyltriethoxysilane, 7.1 g tetraethoxysilane as well as 10.4 g aminoethyl-aminopropyltriethoxysilane and a mixture consisting of 12.2 g H₂O, 0.44 g para-toluenesulfonic acid. The mixture is heated to approx. 45 g and stirred for 60 minutes. Then 5.82 g copper sulphate and 22.1 g silica sol CS 20 516 P are added and stirred for another 24 hours. A translucent, slightly bluish modified resin is obtained.

### Example 7: Application of the Composition According to the Proposed Solution to a Decorative Paper

On an impregnation channel, a decorative paper (basis weight: 70 g/m², width: 2070 mm) was impregnated in a first impregnation step with an aqueous melamine resin (solids content: 55 wt %) in a quantity of 130 g/m². The production speed was 50 m/min. The melamine resin contained the usual additives (hardener, wetting agent, defoamer, etc.).

The impregnate then passed through a drying channel, where it was dried back to a residual moisture of 15-20%.

Then, in a second impregnation step, 40 g melamine resin fl./m² was applied using an anilox roller. This resin contained 2 wt % antiviral agent on solid resin. The melamine resin had a solids content of approx. 55 wt %.

The impregnate is then dried again in a flotation dryer. It is dried to a residual moisture content of 5.5-6.0% by weight. The impregnate is then cut to size (2.8 or 5.6×2.07 m) or rolled up. Formats were then pressed onto chipboard in a short-cycle press, with a zero sample without active ingredient in the surface also being tested. The pressing parameters were: Pressing pressure 40 kg/cm², pressing temperature: 190° C., pressing time: 15 sec.

The usual tests specified within the framework of quality assurance were carried out on the coated panels.

| Exam* | Zero sample | Variant 1 | Variant 2 | Variant 3 | Variant 4 | Variant 5 | Variant 6 |
|---|---|---|---|---|---|---|---|
| Acid test** | Level 1 | Level 1 | Level 1 | Level 1 | Level 1 | Level 1 | Level 1 |
| Scratch test | Grade 3 | Grade 3 | Grade 3 | Grade 3 | Grade 4 | Grade 4 | Grade 4 |
| Water-Steam test | w/o findings | w/o findings | w/o findings | w/o findings | w/o findings | w/o findings | w/o findings |
| Spot un-sensitivity | Level 4 | Level 4 | Level 4 | Level 5 | Level 4 | Level 5 | Level 5 |

*Apart from the acid test, the tests were carried out in accordance with DIN EN 14323- 2017 July. carried out
**Level 1: without findings,
Level 2: slight change in gloss level and/or colour
Level 3: strong change in gloss level and/or colour

As can be seen from the table, no abnormalities were found.

Samples from production were sent to a testing laboratory for “testing of fabrics and materials for antiviral activity with an unenveloped test virus”.

Thereby, all test samples showed a value of antiviral effect A (log 10 PFU) of >3 (ISO 18184:2014-09 Annex G) when tested according to specifications of ISO 21702:2019-05 “Measurement of antiviral activity on plastic and other non-porous surfaces”. Thus, a significant reduction is achieved for all test samples.

### Example 8: Application of the Composition According to the Proposed Solution to an Overlay

On an impregnation channel, an overlay (basis weight: 25 g/m², width: 2070 mm) was impregnated in a first impregnation step with an aqueous melamine resin (solids content: 55 wt %) in a quantity of 135 g/m². The production speed was 50 m/min. The melamine resin contained the usual additives (hardener, wetting agent, defoamer, etc.).

The impregnate then passed through a drying channel, where it was dried back to a residual moisture of 15-20%.

Then, in a second impregnation step, 40 g melamine resin fl./m² was applied using an anilox roller. This resin contained 2 wt % antiviral agent on solid resin. The melamine resin had a solids content of approx. 55 wt %.

The impregnate is then dried again in a flotation dryer. It is dried to a residual moisture content of 5.5-6.0% by weight. The impregnate is then cut to size (2.8 or 5.6×2.07 m) or rolled up. Formats were then pressed in a continuous press to form a laminate. The following structure was used:
Overlay impregnate with antiviral agent (see above)
Decorative impregnate (paper weight: 70 g/m², resin application: 100 wt % melamine resin, VC value: 5.6-6.0%)
Core layer (underlay impregnate NKP; paper weight: 160 g/m², resin application: approx. 85% by weight mixed resin, purchased)
Pergamine (paper weight: 50 g/m²) The pressing parameters were: Feed rate: 8 m/min, pressing pressure 80 kg/cm², pressing temperature: 190° C.

The laminate was then glued to a 38 mm chipboard (adhesive: urea-formaldehyde glue), which had a worktop profile on one side and then the laminate overhang around the glued profile was formed and pressed on in a postforming line.

The laminate can also be used for vertical applications. A decorative impregnate with an antiviral finish can be used instead of the overlay.

### Example 9: Application of the Composition According to the Proposed Solution to an Overlay

On an impregnation channel, an overlay (basis weight: 25 g/m², width: 2070 mm) was impregnated in a first impregnation step with an aqueous melamine resin (solids content: 55 wt %) in a quantity of 135 g/m². The production speed was 50 m/min. The melamine resin contained the usual additives (hardener, wetting agent, defoamer, etc.). After the resin application, corundum was sprinkled on the top side of the overlay with a sprinkling device. This was F 230 (FEPA standard). The application quantity was 20 g/m².

The impregnate then passed through a drying channel, where it was dried back to a residual moisture of 15-20%.

Then, in a second impregnation step, 40 g melamine resin fl./m² was applied to the back of the overlay using a grid roller. This resin contained 2 wt % antiviral agent on solid resin. The melamine resin had a solids content of approx. 55 wt %.

The impregnate is then dried again in a flotation dryer. It is dried to a residual moisture content of 5.5-6.0% by weight. The impregnate is then cut to size (2.8 or 5.6×2.07 m) or rolled up. The formats were then pressed in a short-cycle press to form a floor structure for a laminate floor. The following structure was used:
Overlay impregnate with antiviral agent (see above)
Decorative impregnate (resin application: 100 wt % melamine resin, VC value: 5.6-6.0%)
HDF, 8 mm
Backing impregnate (paper weight: 80 g/m², resin application: 120 wt %)

The pressing parameters were: Pressing pressure 40 kg/cm², pressing temperature: 190° C., pressing time: 12 sec.

The overlay can also be used for a construction for the production of flooring where the HDF has been directly printed. In this case, the overlay is used instead of the final resin application with the antiviral agent.

### Example 10: Application of the Composition According to the Proposed Solution to a Wood-Based Panel

An HDF (format: 2800×2070×7 mm) is first coated with a melamine resin in a direct printing line (application quantity: approx. 20 g melamine resin fl./m², solids content: approx. 65 wt. %). The resin is dried in a circulating air dryer and then a colour base coat consisting of titanium dioxide and casein is applied. This colour base coat is applied up to seven times. The application quantity is 5-10 g primer fl./application. After each application, an intermediate drying is carried out with the help of a circulating air and/or IR dryer. Then a primer is applied (application quantity 10-20 g fl/m²). This is also dried. A decor is then printed onto this primer using gravure or digital printing.

Then a covering layer of melamine resin is applied (application quantity: 10-30 g melamine resin fl./m², solids content: 65 wt %). The melamine resin contains glass beads (diameter glass beads: 80-100 μm, application quantity: 5 g glass beads/m²) as spacers. The panels again pass through a dryer. They are then cooled in a paternoster.

The panels are then coated on a production line on the top side with melamine resin (application quantity: 60 g melamine resin fl./m², solids: 65 wt %). At the same time, a melamine resin is applied as a backing on the reverse side in the same quantity, also with the help of a roller. Then corundum is sprinkled on the top side of the panel (application quantity: 20 g corundum/m², grain size: F230 according to FEPA standard). The structure is aired off or dried in a dryer with the help of IR radiators or circulating air. Subsequently, 30 g melamine resin fl./m² (solids content: 60 wt %) is applied twice more with the help of roller application units. Intermediate drying follows after each application.

In a final roller application, 40 g melamine resin fl./m² was applied using a grid roller. This resin contained 2 wt % antiviral agent on solid resin. The melamine resin had a solids content of approx. 55 wt %.

The panels are dried in a circulating air dryer. The panels are then transferred to a short-cycle press. There the structure is then pressed at T=180° C., p=30 kg/cm² and t=14 sec. A press plate with a deckle structure was used.

### Example 11: Additive AV-30

This is an aqueous additive without residual alcohol, which can be mixed into the resin during production. Alcohol can lead to explosion protection problems in various plants above certain concentrations. Furthermore, the processing of large quantities results in requirements due to emission regulations. Therefore, an attempt was made to modify the additive based on AV-3 in such a way that a purely aqueous, non-flammable additive is created.

Description of the Production of the Additive AV-31:

Prepare 20.0 g glycidyloxypropyltriethoxysilane and 12.8 g tetraethoxysilane in a stirred flask. Addition of a mixture consisting of 18.1 g H₂O and 0.44 g of an ion exchanger (Lewatit 2629). The mixture is heated to approx. 60° C. and stirred for approx. 120 minutes. Then the ion exchanger is sieved off and the mixture is heated to 80° C. under reflux. After 60 minutes, 10.7 g phenylphenol (approx. 22.4 wt. %) are added and the hydrolysate is now kept at 80° C. for a further 60 minutes after the addition of a mixture of 3.3 g demineralised water, 2.1 g dipropylene glycol monomethyl ether and 0.3 g sodium dodecylbenzosulphonate. The alcohol formed during the hydrolysis is removed after 12 hours standing time with the help of a rotary evaporator (approx. 19 g). The flash point of this additive is now >85° C. This additive can now be added to aqueous melamine resin.

Production trials have shown that insufficient mixing (e.g. downtimes of the plant or insufficient speed during mixing) can lead to segregation phenomena and thus to optical inhomogeneity, which strongly disturbs the optical appearance of the furniture surface.

Laboratory tests showed that this is mainly due to the phenylphenol content. The maximum content of phenylphenol without segregation is ≤20 wt. %.

In order not to reduce the effectiveness of the additive and not to jeopardise production safety, the phenylphenol content was therefore slightly reduced and replaced by another approved biocidal product (4-chloro-3-methylphenol).

### Example 12: Additive AV-34+

Description of the Production of the Additive AV-34+:

Prepare 20.0 g glycidyloxypropyltriethoxysilane and 12.8 g tetraethoxysilane in a stirred flask. Addition of a mixture consisting of 18.1 g H₂O and 0.44 g of an ion exchanger (Lewatit 2629). The mixture is heated to approx. 60° C. and stirred for approx. 120 minutes. Then the ion exchanger is sieved off and the mixture is heated to 80° C. under reflux. After 60 minutes, 9.56 g phenylphenol (approx. 20 wt. %) and 0.23 g 4-chloro-3-methylphenol (approx. 0.48 wt. %) are added and the hydrolysate is now kept at 80° C. for a further 60 minutes after addition of a mixture of 3.3 g demineralised water, 2.1 g dipropylene glycol monomethyl ether and 0.3 g sodium dodecylbenzosulphonate. The alcohol formed during the hydrolysis is removed after 12 hours standing time with the help of a rotary evaporator (approx. 19 g). The flash point of this additive is now >85° C. This additive can now be added to aqueous melamine resin.

Laboratory tests showed that this low addition of the 4-chloro-3-methylphenol does not cause any odour nuisance from the new biocide. Only at a concentration above 0.8 wt. % can the 4-chloro-3-metyhlphenol be perceived odourously at processing temperatures above 150° C. Apart from the odour nuisance, we can increase the content of 4-chloro-3-metyhlphenol up to also 28 wt. % without detecting any inhomogeneity.

Practical tests show that there is now no inhomogeneity in the surface even with longer standing times and segregation could not be observed.

Antiviral Tests:

The antiviral compositions were tested for antiviral activity according to ISO 217022:2019-05 “Measurement of antiviral activity on plastic and other non-porous surfaces”.

The results showed significant antiviral activity for AV-1 to AV-6 with respect to bacteriophage MS2 (DSM 13767) with a log 10 PFU above 4.5.

A virus reduction of 97.2% was also demonstrated with regard to bovine coronavirus (BoCV).

1. A resin-containing composition having antimicrobial properties, in particular antiviral properties, for surface coatings of paper layer or wood-based panels, said composition comprising:
at least one formaldehyde resin, in particular a melamine-formaldehyde resin,
at least one compound of the general formula (I)
R¹SiX₃ (I),
where
X is alkoxy, and
R¹ is an organic moiety selected from the group comprising C1-C10 alkyl which may be interrupted by —O— or —NH—, and
wherein R¹ has at least one functional moiety Q₁ selected from a group containing an amino, methacrylic, methacryloxy, vinyl and epoxy group,
at least one further compound of the general formula (II)
SiX₄ (II),
where X is alkoxy, and
at least one antimicrobial agent, in particular at least one biocide.

2. The composition according to claim 1, wherein is selected from a group containing C₁₋₆ alkoxy, in particular methoxy, ethoxy, n-propoxy, i-propoxy and butoxy.

3. The composition according to claim 1, wherein R¹ of the compound of general formula (I) is selected from a group comprising methyl, ethyl, propyl, pentyl, hexyl, heptyl, octyl, which may be interrupted by —O— or —NH—.

4. The composition according to claim 1, wherein the at least one functional moiety Q1 of the compound of general formula (I) is selected from a group comprising epoxide, amino and vinyl group.

5. The composition according to claim 1, comprising least one compound of the general formula (I) and at least one compound of the general formula (II), or at least two compounds of the general formula (I) and at least one compound of the general formula (II).

6. The composition according to claim 1, wherein at least one biocide is selected from a group comprising benzalkonium chloride, chitosan, phenylphenol, copper sulphate, 4-chloro-3-methylphenol.

7. The composition according to claim 1, wherein at least two biocides, in particular phenylphenol and 4-chloro-3-methylphenol, are present.

8. The composition according to claim 1, comprising inorganic particles, in particular nanoparticles, preferably based on SiO₂ (silica sol, zeolites).

9. The composition according to claim 1, comprising at least one alkoxytitanate such as Tetraisopropyl orthotitanate (titanium isopropylate) or tetraisobutyl orthotitanate (titanium isobutylate).

10. (canceled)

11. A wood-based panel or paper layer, preferably decorative paper layer or overlay paper layer, coated with at least one resin-containing composition according to claim 1.

12. (canceled)

13. A method for producing a paper layer or wood-based panel provided with an antiviral effect, wherein at least one paper layer or wood-based panel is provided with at least one coating, in particular at least one surface coating, comprising a resin-containing composition according to claim 1.

14. The method according to claim 13, wherein at least one paper layer is a decorative paper layer or overlay paper layer.

15. The method according to claim 13, comprising the following steps:
impregnating the at least one paper layer with a resin suspension;
applying at least one antivirally active coating comprising a resin-containing composition to at least one impregnated paper layer; and
drying of the paper layer with formation of an impregnate.

16. The method according to claim 13, wherein the at least one wood-based panel is a wood chip panel, medium-density fibre (MDF), high-density fibre (HDF) or oriented strand board (OSB), plywood panel or a plastic composite panel (WPC).

17. The method according to claim 13, comprising the following steps:
applying at least one decorative layer, in particular in the form of a direct print or a decorative paper layer, to the at least one wood-based panel;
applying to the at least one decorative layer at least one antivirally active coating comprising a resin-containing composition comprising: at least one formaldehyde resin, in particular a melamine-formaldehyde resin,
at least one compound of the general formula (I)
R¹SiX₃ (I)
where
X is alkoxy, and
R¹ is an organic moiety selected from the group comprising C1-C10 alkyl which may be interrupted by —O— or —NH—, and
wherein R¹ has at least one functional moiety Q₁ selected from a group containing an amino, methacrylic, methacryloxy, vinyl and epoxy group,
at least one further compound of the general formula (II)
SiX₄ (II)
where X is alkoxy, and
at least one antimicrobial agent, in particular at least one biocide to the at least one decorative layer; and
pressing the layer structure to form a laminate.

18. (canceled)

19. (canceled)
